(19) United States
(12) Patent Application Publication
(10) Pub. No.: US 2021/0231939 A1
(43) Pub. Date: Jul. 29, 2021

(54) MICROSCOPE AND METHOD FOR CAPTURING A MICROSCOPIC IMAGE AND USE OF A PLANAR REFLECTOR

(71) Applicant: JENOPTIK Optical Systems GmbH, Jena (DE)

(72) Inventors: Norbert LECLERC, Heidelberg (DE); Juergen WOLF, Schloeben (DE)

(73) Assignee: JENOPTIK Optical Systems GmbH, Jena (DE)

(21) Appl. No.: 16/972,401

(22) PCT Filed: Jun. 3, 2019
(86) PCT No.: PCT/EP2019/064311

§ 371 Date: Dec. 4, 2020

(30) Foreign Application Priority Data
Jun. 4, 2018 (DE) 10 2018 113 182.8
Aug. 17, 2018 (DE) 10 2018 120 099.4

(51) Int. Cl. G02B 21/14

(52) U.S. Cl. CPC G02B 21/14

(57) ABSTRACT

The invention relates to EPI lighting which allows transmitted light-bright field- or transmitted light-dark field-imaging or phase contrast imaging of a microscopic sample. For this purpose, a flat reflector is used which is located opposite the observer side and which brings about a deflection of the illumination beam of light. The flat reflector has a plane normal and an effective perpendicular which differs from the plane normal, or it is in the form of a retroreflector.

This nonprovisional application is a National Stage of International Application No. PCT/EP2019/064311, which was filed on Jun. 3, 2019, and which claims priority to German Patent Application No. DE 10 2018 113 182, which was filed in Germany on Jun. 4, 2018 and German Patent Application No. 10 2018 120 099, which was filed in Germany on Aug. 17, 2018 and which are all herein incorporated by reference.

### BACKGROUND OF THE INVENTION

### Field of the Invention

The present invention relates to a method for illuminating a microscopic object, a microscope and the use of a plate-shaped reflector.

### Description of the Background Art

A Fresnel prism is known from JP2000019310 and JP2000019309.

A Fresnel prism for illumination purposes is known from JPH11344605.

A light modulation element with a Fresnel structure is known from WO2014080910.

A transmitted light microscope with prismatic illumination beam deflection is known from JPH10288741.

“Hoffman Modulation Contrast”; Abramowitz, M.; Davidson M. W. in http://micro.magnet.fsu.edu/primer/techniques/hoffman/hoffmanintro.html has disclosed a microscope based on the Hoffman modulation contrast method.

Retroreflectors are well known; e.g., https://de.wikipedia.org/wiki/Retroreflektor. In addition to the conventional macroscopically structured retroreflectors, there are those with microstructures as reflection elements. EP0200521A2 describes retroreflective flat materials that use small glass beads which are embedded in a matrix made of synthetic resin. Similar retroreflectors are also known from U.S. Pat. No. 4,957,335A, WO9822837A1, WO03070483A1 and WO2006085690A1. WO2006136381A1, DE102009060884A1, DE29701903U1 and DE29707066U1 describe retroreflective flat materials that use microprismatic formations which cause back-reflection properties. A retroreflective film is known from U.S. Pat. No. 3,689,346A. DE4117911A1 describes a back-reflecting flat material which generates back-reflected light with a slight divergence. Further microretroreflectors are known from DE102005063331A1 and EP0880716A1 and WO200223232A2.

AT508102A1 has disclosed an illumination device for a microscope with ring illumination for dark field illumination from below or bright field transmitted light illumination.

U.S. Pat. No. 5,285,314 has disclosed a diffractive mirror with a multiplicity of diffractive zones.

### SUMMARY OF THE INVENTION

It is therefore an object of the present invention to facilitate a transmitted light recording, bright field recording or dark field recording and/or a phase contrast recording of a sample with space-saving epi-illumination. Moreover, it should be possible to scan a plurality of samples or a plurality of points on a sample.

### Advantages of the Invention

The invention facilitates compact illumination for a microscope. Both the illumination and the observation can advantageously be implemented from below. This allows a use in cell biology or as a cell microscope. The present invention also allows transparent and/or semitransparent objects in a sample to be examined microscopically in a simple manner.

### Achieving the Object

The object is achieved by the use as claimed in claim 1, a method as claimed in claim 2 and a microscope as claimed in claim 19.

### Description

The method according to the invention serves to record at least one microscopic image of a sample. The method can be particularly advantageous when the intention is to examine transparent and/or semitransparent objects. These can be present in a liquid, for example water, a nutrient solution, oil or formaldehyde. Examination objects can be, for example, plant, animal or eukaryotic cells or cell clusters, cell organelles and their components, for example chromosomes, viruses, bacteria, antibodies, pollen, sperm, macromolecules, for example peptides, lipids, DNA, RNA, or molecular clusters.

An optical axis can be introduced in a z-direction. The x- and y-directions can be specified perpendicular to z and are also perpendicular to each other. The x-, y- and z-directions can form a right-angled coordinate system. The optical axis can be the optical axis of a microscope objective.

In a first embodiment of the invention, the following method for recording a microscopic image is presented. In the process, the image representation of at least one region of at least one sample is recorded. The sample is arranged in a sample plane. The sample plane can be perpendicular to the optical axis, which can be specified along the z-direction. The recording is implemented from a first side. This allows the observation direction to be specified.

This method comprises generating at least one beam with the aid of at least one light source. The beam can also be referred to as an illumination beam. Advantageously, exactly one light source can be provided. However, a plurality of light sources can also be provided. The light source can emit light with a spectral distribution. By way of example, it can be infrared, visible or ultraviolet light.

Moreover, the method comprises guiding the beam through the sample plane up to a plate-shaped reflector. For the plate-shaped reflector, it is possible to define a plate normal and a substitute perpendicular, deviating from the plate normal, in respect of the illumination beam. The plate normal can lie in the direction of the optical axis, i.e., in the z-direction. Then, the plate surface can lie in an xy-plane. The plate can have a structure that causes an incident light ray to be reflected about the substitute perpendicular. Exactly one individual reflection or else a plurality of individual reflections can be provided. This can mean that the emergent light ray leaves the reflector after exactly one individual reflection or after a plurality of individual reflections. A substitute perpendicular can be understood to mean the direction of an angle bisector between the incident and emergent light ray. The substitute perpendicular can also be referred to as the effective incidence perpendicular with respect to an incident light ray. The central ray of the incident light beam can be chosen as the reference ray for determining the substitute perpendicular. The substitute perpendicular can also be understood as the direction of the difference vector of the normalized emergence vector and the normalized incidence vector. The normalized incidence vector or emergence vector can be the direction vector of the incident or emergent light ray. If, as is the case with a retroreflector, for example, the direction of incidence and emergence are exactly opposite, the substitute perpendicular can be defined as the direction of the emergence vector. The use of the term substitute perpendicular to describe the method or the subject matter of the present invention can be redundant in this case. If a retroreflector is used as a reflector, the definition of the substitute perpendicular can be dispensed with. In a preferred embodiment, the method comprises guiding the beam through the sample plane to a plate-shaped reflector, the reflector being a retroreflector.

The substitute perpendicular can be fixed, i.e., independent of the angle of incidence. To deflect the beam, a simple reflection on a reflection surface can be provided for each ray, i.e., exactly one individual reflection. The substitute perpendicular can then be the same as the incidence perpendicular of the respective ray on the reflection surface. In this case, the substitute perpendicular can correspond to the surface normal of the reflection surface.

However, the substitute perpendicular can also be dependent on the direction of the incident light ray. This can be the case, in particular, if the reflection at the reflector comprises a plurality of individual reflections, for example two individual reflections.

Moreover, the method comprises deflecting the beam by the reflector. Moreover, the method comprises illuminating the sample with the deflected beam. Moreover, the method comprises recording the microscopic image using an image sensor. The microscopic image can be an intensity contrast image. Advantageously, the microscopic image could also be, but need not be, a phase contrast image. A microscopic image that represents a superposition of a phase contrast image with an intensity contrast image can likewise be advantageous.

The use of at least one plate-shaped reflector for deflecting at least one illumination beam is advantageous. The illumination beam serves to illuminate at least one sample. The stated use is intended for recording at least one microscopic image of the sample from a first side. The image is recorded using an image sensor. The plate-shaped reflector has a plate normal and a substitute perpendicular, deviating from the plate normal, in respect of the illumination beam and is arranged on a second side which is opposite the first side with respect to the sample. In more precise terms, opposite can be understood to be in relation to the sample plane.

The sample can be arranged in a horizontal sample plane, for example in an xy-plane. The microscopic image can advantageously be recorded from above in relation to the force of gravity. Then, the first side can be the upper side of the sample. The second side can then be the lower side of the sample. This makes it possible to illuminate the sample using the transmitted light method, even if the illumination and the image recording take place from the same side, specifically the first side, in the sense of epi-illumination. Epi-illumination is to be understood to mean illumination that is implemented from the same half-space as the observation. This half-space can be defined with respect to the sample plane. The reflector can advantageously be arranged in the other half-space.

The microscopic image can particularly advantageously be recorded from below in relation to the force of gravity. Then, the first side can be the lower side of the sample. The second side can then be the upper side of the sample.

The image can be recorded through a microscope objective. To this end, the microscope objective can be provided as a first Fourier lens. Moreover, a camera lens, which can be provided as a further Fourier lens, specifically a second Fourier lens, can be present. The arrangement of both Fourier lenses can bring about an image representation of the sample on the sensor. The camera lens can also be referred to as a tube lens. However, a camera lens need not necessarily be present. The microscope objective itself can be provided for imaging the sample on the image sensor. Imaging on the image sensor can therefore also be implemented without a camera lens if the microscope objective is embodied accordingly. The beam can advantageously be guided through the microscope objective to illuminate the sample. However, it can also be advantageous to guide the beam of the illumination past the microscope objective. In the latter case, the objective can be made smaller because the illumination beam need not be guided through the objective.

The beam of the illumination can advantageously be guided through the microscope objective before the deflection by the reflector.

The sample can be illuminated with the deflected beam in a beam direction at a mean elevation angle β and a mean azimuth angle γ. The beam can advantageously be collimated before it is deflected in order to illuminate the sample with parallel light. However, there may also be deviations from parallelism. Then, a mean elevation angle β and a mean azimuth angle γ of the beam can be specified.

The deflected beam can have a central ray. The central ray of the beam can be regarded as the central ray. The incident beam can likewise have a central ray. This can be the ray of the incident beam that leaves the reflector as the central ray of the deflected beam. A spherical coordinate system can be used to specify the azimuth angle γ and the elevation angle β, the zenith describing the optical axis which might lie along the z-direction. The azimuth angle can be specified in relation to the x-direction. The x-direction can be specified in such a way that the xz-half-plane with positive x comprises a central ray of the deflected light beam. The elevation angle can be the angle of the central ray of the deflected beam with respect to the xy-plane. The elevation angle can be determined as 90° minus the angle of the central ray of the deflected beam with respect to the optical axis of the microscope objective. By way of example, the elevation angle can be between 45° and 90°, particularly advantageously between 70° and 85°. The elevation angle can advantageously be chosen to be smaller than a right angle. This can correspond to an oblique incidence of the beam on the sample; this is also called oblique illumination. In this way, the contrast can be improved in the case of transparent and/or semitransparent objects in the sample. The central ray of the deflected beam can therefore run at an angle to the optical axis.

However, the elevation angle can also be chosen to be 90°. Then, the central ray of the deflected beam can be parallel to the optical axis.

If a plurality of beams are provided, the beams can have the same elevation angle β. These can be arranged evenly distributed in the azimuthal direction. By way of example, the azimuth angle of the first beam can be 0° and that of a second beam can be 180°.

The light source can advantageously be embodied as an LED. It can be arranged in a pupil plane (22) or in a plane conjugate to the pupil plane. The pupil plane can be the plane in which a stop is situated. The pupil plane can be the focal plane of the microscope objective opposite the sample. A slight deviation of the position of the LED from the pupil plane can be neglected. It is therefore possible, for example, to attach the LEDs to the stop ring. A conjugate plane can be understood to mean a plane that is projected onto the pupil plane by means of a relay optical unit. The relay optical unit can be designed as a relay lens or comprise two Fourier lenses, for example.

The light source can be embodied as an LED and can have a diffuser arranged directly in front of each light-generating surface. The diffuser can be provided to homogenize the direction-dependent intensity distribution. The arrangement directly in front of the light-generating surface can cause directional homogenization to be implemented without the emitting surface being significantly enlarged.

The light sources can advantageously have a diameter of the luminous surfaces, which is less than 30% of the focal length of the microscope objective. The luminous surface of the light source can be circular, square or rectangular, for example. By way of example, the light source can be an LED chip or a housed SMD LED.

The light beam can be polarized linearly in a first polarization direction. Alternatively, the light beam can be unpolarized.

The sample can comprise a liquid sample substance. It can be situated on a sample carrier. With regard to the force of gravity, the sample carrier can be at the bottom and the liquid sample substance at the top. This can prevent the sample substance from dripping off. In this case, illumination and observation of the sample from below can be advantageous. A transparent sample carrier can be expediently used for this purpose. Here, the first side can be the lower side. In this case, the reflector can be arranged above the sample. The sample can comprise a cover, for example a cover slip.

The microscope or the microscope objective can have a field of view. In the case of a predetermined focal plane, the field of view can be a region in the focal plane that can be captured with the image sensor. The focal plane can be the plane that can be imaged on the image sensor in focus. The focal plane can be perpendicular to the optical axis. The focal plane can expediently be located in the sample. The focal plane can coincide with the sample plane. The microscope can then be focused on the sample plane. The beam path can be provided in such a way that the deflected beam completely illuminates the field of view.

The beam can have an intersection with the focal plane before deflection. The intersection can contain the field of view. Then, the sample can be illuminated from two sides. In this way, simultaneous incident and transmitted light illumination of the sample can be realized. Certain patterns in the sample can be better recognized using such a combined incident and transmitted light illumination.

The intersection can likewise advantageously be located outside the field of view. This can mean that the beam is guided through the sample plane at a point located outside of a field of view. Then, the sample can only be illuminated using the transmitted light method, i.e., from the back side. The back side can be the second side.

The deflected beam can also have a further intersection with the focal plane, which can be referred to as the sample area illuminated by the deflected beam. The sample area illuminated by the deflected beam can advantageously contain the field of view.

The deflected beam can be provided as a beam of parallel rays. For this purpose, the beam can already be present as a parallel beam before deflection at the reflector. However, it can also be advantageous to direct the deflected beam at the sample in convergent or divergent fashion. The vergence of the beam can be retained when it is deflected. The provision of vergence and/or the diffuser can also have the effect that the reflection of the beam becomes less sensitive to, for example, tilting of the sample, unevenness of the reflector, etc.

The reflector can be embodied as a Fresnel prism. A Fresnel prism is known from JP2000019310 and JP2000019309, for example. The Fresnel prism can comprise a plurality of reflection surfaces with reflection surface normals. The reflection surface normals can be inclined with respect to the plate normal. The reflection surface normals can each be the incidence perpendicular of an incident ray. The incidence perpendicular can correspond to the substitute perpendicular of the reflector. The beam deflection at the Fresnel prism can be implemented by a simple reflection. The Fresnel prism can have a periodic structure. Exactly one reflection surface can be provided in each period. The reflection surface normals of the Fresnel prism can be parallel.

The reflector can be embodied in one piece as a plate or a film. A film can be thought of as a thin plate. The reflector can be embodied as a layer on a carrier plate or a carrier film. This layer or the surface of the plate can have a step structure. The reflector can be embodied in such a way that a plurality of rays of the beam, which have been deflected at different reflection surfaces of the reflector, contribute to the illumination of the field of view.

The reflector can be embodied as a periodic relief structure. A periodic structure can exist in one direction, for example in the x-direction. However, it is also possible to use a structure which is periodic in two directions, for example in the x- and y-directions.

It can be advantageous if there are at least two reflection surfaces in each period. The reflector can deflect an incident light ray of the beam by means of at least two successive individual reflections. Advantageously, exactly two reflection surfaces can be provided in each period. In this case, the substitute perpendicular can be different from the incidence perpendicular of the first individual reflection. Likewise advantageously, more than two reflections, for example three reflections, can be provided.

The reflector can be embodied as a microprism array and/or a microlens array.

The reflector can be embodied as a retroreflector in relation to a plurality of beam directions. Such an embodiment can be embodied specifically as a cat's eye or as a retroreflective reflector with, for example, three-face corner reflectors. In this case, the incident beam can be deflected by three reflections.

In an alternative embodiment, the reflector can bring about a deflection of the incident beam that deviates from a retroreflection with respect to a plurality of beam directions. The angle difference between an incident ray and the associated emergent ray can be independent of the angle of incidence in a certain angular range. This can mean that a substitute perpendicular varies with the angle of incidence in this angular range. Such a reflector can have V-grooves with a roof angle, for example. A roof angle of 90° can cause a retroreflection, while another, preferably smaller, angle causes a deflection of the incident beam that deviates from a retroreflection. Due to a plurality of individual reflections on both sides of the V-grooves, the angle difference between an incident and the associated emergent ray can be independent of the angle of incidence in a certain angular range.

The beam of the illumination incident on the sample can be split into at least one first beam and at least one second beam in the sample and/or by refraction at a sample back side. By way of example, such a split can be brought about by differences in the refractive index within the sample, internal optical interfaces within the sample, a curved sample back side and/or the formation of menisci, for example in the case of a liquid sample. The second beam can impinge on the reflector at a different angle of incidence to the first beam. In this case, the use of a retroreflector as a reflector can be particularly advantageous. This is because, by using the retroreflector, the first and the second beam can each be reflected back into themselves and thus be reflected back to the same point on the sample from which they originated. In this way, particularly uniform illumination of the sample can be achieved. Naturally, a multiplicity of individual beams can also arise during the splitting. Their number is not limited to a first and a second beam. The presentation of a first and a second beam is for illustration purposes only.

When the reflector is embodied as a retroreflector, the associated emergent ray can be directed exactly in the opposite direction to the incident ray—at least in a certain angular range. In this case, the substitute perpendicular can be the direction of the emergent light ray. The term substitute perpendicular can be redundant in this case. Therefore, if the reflector is embodied as a retroreflector, the use of the term substitute perpendicular can be dispensed with. In a further embodiment, the retroreflector can be embodied in such a way that, as known from DE4117911, it effects light reflection in a slightly divergent manner.

It is particularly advantageous to use an oblique illumination to record a transmitted light bright field image and/or transmitted light dark field image.

The recording of the image can particularly advantageously be implemented as a superposition of a transmitted light bright field image with a phase contrast image. The recording of the image can likewise advantageously be implemented as a superposition of a transmitted light dark field image with a phase contrast image.

At least one phase plate can additionally be provided in the case of a phase contrast image. By way of example, it can be arranged in the stop plane. In this case, coaxial illumination through the microscope objective can be advantageous. The phase plate can comprise a retardation plate and a neutral density filter. The phase plate can be embodied as a phase ring. The phase contrast image with the reflector according to the invention can be recorded, for example, with one of the known methods according to Zernicke, relief phase contrast according to DE102012005911, or luminance contrast according to DE102007029814.

It is also possible to record a varel contrast image. In the latter case, the varel contrast method is used, in which use is made of a superposition of oblique bright field illumination with phase contrast.

Recording with Hoffman's modulation contrast method according to U.S. Pat. Nos. 4,062,619, 4,200,353 or 4,200,354 is also possible. A Hoffman modulator can be provided, preferably in the pupil plane, in this case. The modulator can have a three-part embodiment, with three segments with different optical attenuation being present. The middle segment can be arranged centrally or eccentrically with respect to the optical axis. In addition, a light source stop can be provided, preferably in a plane of the illumination beam path that is conjugate to the pupil plane. The light source stop can be designed as a slit stop. The slit stop can preferably be partially covered by a polarization filter. The slit can be arranged centrally or eccentrically with respect to the illumination beam path. In addition, a further polarization filter can be present in the illumination beam path.

In the case of a retroreflector, however, a beam offset can occur between the incident ray and the associated emergent ray. Such a beam offset can be up to a few millimeters in the case of a retroreflector with macroscopic reflection elements, for example a conventional reflector (cat's eye) from the bicycle shop. In order to keep the beam offset as low as possible, it can be advantageous to use a microprism array or encapsulated micro glass beads as a retroreflector. Such retroreflectors are available, for example, as films in the retro-reflection classes RA1, RA2, RA 2/B, RA 2/C and RA3 for street signs, for example the 3M™ Engineer Grade Prismatic Series 3430 film according to “Technical Information SG 103/10.2017” from Company 3M Deutschland GmbH or the microprismatic retroreflective sheeting Avery Dennison® T T7500B. Microcube reflectors that can be constructed as full cube triple arrays can be suited even better thereto. As an example of a full cube reflector, the reflector “3M™ Diamond Grade DG 3. Reflective Sheeting” can be used. Microstructures made of triangular mirrors, also referred to as pyramidal triples, can also be suitable. Pyramidal triple arrays can be more cost-effective than full cube arrays. Full cube or pyramidal triple arrays can, for example, be produced in a plastic injection molding process or embossed into a plastic substrate, a glass substrate or a flexible plastic film.

The beam of the illumination can advantageously be guided through the microscope objective onto the sample. Such a beam guidance can be advantageous, particularly when using a retroreflector. Such a beam guidance can also be used, in particular, for phase contrast recordings.

The reflector can also cause diffraction and interference of the light. In principle, the reflector can also be embodied as a reflection grating, preferably as a blazed grating. However, this can have the disadvantage that large-area blazed gratings are currently very expensive. In addition, the wavelength-dependent diffraction angles that occur in a grating can be disadvantageous. It can therefore be advantageous to minimize diffraction effects. By way of example, the structure widths of the reflector can be selected so large that the reflection angle corresponds to at least the more than tenth, preferably more than thirtieth and particularly preferably more than hundredth order of diffraction of a blazed grating. By way of example, the period of the reflector can be between 50 micrometers and 5 millimeters, preferably between 0.1 millimeters and 2 millimeters. Then beams diffracted in different diffraction orders or split up by a dispersion can be mixed due to the spectral width of the light source and/or the vergence of the beam at the location of the sample. As a result, diffraction and dispersion effects can be avoided when the beam is deflected at the reflector. The period of the reflector can likewise advantageously be between 5 μm and 100 μm. Even though such fine structures are more difficult to manufacture, this can be advantageous on account of the small beam offset.

In another embodiment, a front projection screen, for example one based on reflection volume holograms, as known from “Tageslichttaugliche Aufprojektionsschirme auf Basis von Reflexions-Volumenhologrammen [Daylight suitable front projection screens based on reflection volume holograms]”; von Spiegel, Wolff, Darmstadt (2006), http://elib.tu-darmstadt.de/diss/000799, can be used as a reflector.

In a further embodiment, use can be made of a retroreflector which has both holographic and retroreflective layers. Such a reflector is described in U.S. Pat. No. 5,656,360.

The reflector can advantageously be arranged at a distance from the sample plane, which can be measured along the optical axis, i.e., in the z-direction, and which is equal to or greater than half the focal length, particularly advantageously greater than the single focal length of the microscope objective. As a result, artifacts due to local defects in the reflector, for example individual faulty or soiled microprisms, can be avoided. This distance can advantageously be selected to be smaller than 10 times, particularly advantageously smaller than 5 times, the focal length of the objective. If the distance is too great, angular errors in the prisms could otherwise cause artifacts in the microscopic image, for example. The plate normal of the reflector can advantageously be chosen to be parallel to the optical axis, i.e., in the z-direction. The distance between the reflector and the sample plane can advantageously be fixed. Alternatively, this distance can be modifiable, but this can be more complex. The light source can advantageously be chosen in such a way that its coherence length is less than twice the aforementioned distance. Artifacts due to interference between transmitted light illumination and reflected light illumination can then be avoided. Alternatively, the light source can be chosen in such a way that its coherence length is greater than twice the aforementioned distance. Then, as a result of interference between transmitted light illumination and reflected light illumination, contrasts of certain objects in the sample can be exaggerated.

The retroreflector can be embodied in such a way that the beam offset between an incident and an emergent ray is at most less than 100 μm. Retroreflectors made of microprism arrays with a period of less than 100 μm or retroreflectors with micro glass spheres of less than 100 μm in diameter can be suitable for this purpose. A retroreflector in which the full width at half maximum of the backscattered light intensity is less than 5°, particularly advantageously less than 3° and very particularly advantageously less than 1°, can advantageously be chosen. An incident beam can then be reflected back into itself as precisely as possible. As a result, a contrast that is as high as possible can be obtained in the microscopic image. The full width at half maximum of the backscattered intensity can likewise advantageously be greater than 20 arcminutes. Then small angle errors of the prism angles can be compensated. A retroreflector of the lighting performance class RA3 (formerly “Type 3”) can be particularly advantageous. Such retroreflectors can have or exceed a minimum reflection value of 300 cd/lx per m² at an illumination angle of 5° and a viewing angle of 0.33°.

The deflected beam can bring about a transmitted light bright field illumination or one or a transmitted light dark field illumination of the sample.

In an advantageous embodiment, it is possible to record a plurality of microscopic images of a plurality of samples and/or a sample at a plurality of points. A microscope camera that comprises the image sensor can be used for this purpose. In addition, the microscope camera can comprise a camera lens. The microscope camera can be moved, from the recording of one image to the recording of a next image, with respect to the samples or the sample in each case. The reflector can be fixedly arranged with respect to the samples or the sample. This can mean that it is not moved with the camera. The light source can be fixedly arranged with respect to the microscope camera. This can mean that the light source is moved along with the microscope camera in each case.

A microscope for recording at least one transmitted light bright field image or transmitted light dark field image of at least one sample in at least one field of view is advantageous, said microscope comprising
a beam path comprising at least one illumination beam path and at least one imaging beam path,
at least one light source for generating at least one beam,
a plate-shaped reflector for deflecting the beam, the deflected beam being provided for illuminating the sample and the plate-shaped reflector having a plate normal and a substitute perpendicular, deviating from the plate normal, in respect of the illumination beam,
at least one microscope objective for the imaging beam path,
at least one image sensor.

A microscope for recording at least one image of at least one sample in at least one field of view can be particularly advantageous, said microscope comprising
a beam path comprising at least one illumination beam path and at least one imaging beam path,
at least one light source for generating at least one illumination beam,
a plate-shaped reflector for deflecting the illumination beam, the deflected illumination beam being provided for illuminating the sample, and the reflector being embodied as a retroreflector,
at least one microscope objective for the imaging beam path,
at least one image sensor,

wherein the illumination beam is guided through the microscope objective before being deflected at the reflector. Here the microscope objective can thus be used both for the illumination beam path and for the imaging beam path. Both the not yet deflected illumination beam and the deflected illumination beam can be provided at the same time for illuminating the sample.

In this case, the light source, the microscope objective and the image sensor can be arranged on one side of the sample in the sense of epi-illumination, whereas the reflector can be arranged on the other side of the sample. Geometrically, such an embodiment of the invention can be described more precisely as the light source, the microscope objective and the image sensor being arranged in a common half-space with respect to the sample plane, the reflector being arranged in the other half-space.

The illumination beam path can be provided parallel to the optical axis. This facilitates a cost-effective structure. The illumination beam path can likewise advantageously be provided at an angle to the optical axis. This can improve the contrast of the recording.

In addition, the microscope can include a camera lens.

Advantageously, particularly if the illumination beam path or the illumination beam paths are inclined with respect to the optical axis, at least one second light source can be present in addition to the first light source. A second illumination beam can be generable with the second light source. The second light source can be operable independently of the first light source. The plate-shaped reflector can moreover be provided for deflecting the second beam. The deflected second beam can be provided for illuminating the sample. Here, the second beam can cause a second illumination situation that is different from a first illumination situation. Such a microscope can also be used advantageously to record a plurality of images for the methods described above. In this case, the microscope can have a plurality of, for example two, light sources and illumination beam paths. The first recording can be illuminated with the first light source and a second recording can be illuminated with a second light source. A sum image and/or a difference image, which can have an improved contrast compared to the individual images, can then be calculated from the two images.

The microscope can advantageously have a focal plane that can be imaged on the image sensor in focus. The field of view that is able to be captured with the image sensor can be provided in the focal plane. The illumination beam can have an intersection with the focal plane in the beam path before deflection at the reflector. This intersection can contain the field of view. In this way, combined incident light illumination and transmitted light illumination of the sample can be achieved. This can be particularly advantageous if the illumination is implemented through the microscope objective.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus, are not limitive of the present invention, and wherein:

FIG. 1 shows a first exemplary embodiment.

FIG. 2 shows a second exemplary embodiment.

FIG. 3 shows a third exemplary embodiment.

FIG. 4 shows a fourth exemplary embodiment.

FIG. 5 shows a fifth and a sixth exemplary embodiment.

FIG. 6 shows a seventh exemplary embodiment.

FIG. 7 shows a first embodiment of the illumination beam path in a sectional plane.

FIG. 8 shows a second embodiment of the illumination beam path in a sectional plane.

FIG. 9 shows a light source.

FIG. 10 shows an eighth exemplary embodiment.

FIG. 11 shows a ninth exemplary embodiment.

FIG. 12 shows a tenth exemplary embodiment.

FIG. 13 shows a beam deflection at an element of a microprism array.

FIG. 14 shows a section from a reflector.

### DETAILED DESCRIPTION

FIG. 1 shows a first exemplary embodiment. An apparatus for recording at least one microscopic image 1, which apparatus can also be referred to as a microscope, is shown. The optical axis 2 of the microscope objective lies in the z-direction. A sample 7 with transparent and/or semitransparent objects 9 is situated on a sample carrier 10. The microscope comprises a microscope objective 20 with an optical axis 2. The light source 17 is arranged slightly in front of the pupil plane 22. The pupil plane is the xy-plane in which the stop 21, which can also be referred to as the pupil, is situated. This arrangement of the light source causes a slight divergence of the beam 3. Alternatively, the light source can be arranged in the pupil plane in order to generate a parallel beam (not shown).

The plane 16 is the focal plane, in which objects are imaged on the image sensor 25 in focus. The focal plane simultaneously is the sample plane 8 in which the sample is arranged.

The beam 3 is guided through the sample plane 8 to a plate-shaped reflector 11. The plate-shaped reflector 11 has a plate normal 12 and a substitute perpendicular 14, deviating from the plate normal, in respect of the illumination beam 3. The reflector 11 is embodied as a Fresnel prism. The Fresnel prism comprises a plurality of reflection surfaces 13 with reflection surface normals 14. The reflection surface normals are inclined with respect to the plate normal 12. The reflection surface normals each are the incidence perpendicular of an incident ray. The incidence perpendicular corresponds to the substitute perpendicular of the reflector. The reflector has a periodic structure with a period 29 in the x-direction. Each period 29 comprises a reflection surface. The steep flanks between the reflection surfaces 13, however, are not intended for reflection.

The deflection of the beam 3 by the reflector 11 is also shown. The deflected beam 4 has a central ray 5. The sample is illuminated with the deflected beam 4.

In addition, a camera 23 is shown, which comprises a camera lens 24 and an image sensor 25. One or more microscopic images of the sample can be recorded with an image sensor 25. In order to clarify the imaging beam path, light rays 6 from the object are shown here.

The illumination shown in FIG. 1 is a bright field transmitted light illumination. The direction of gravity here is the z-direction. The sample is therefore illuminated from below and observed from below.

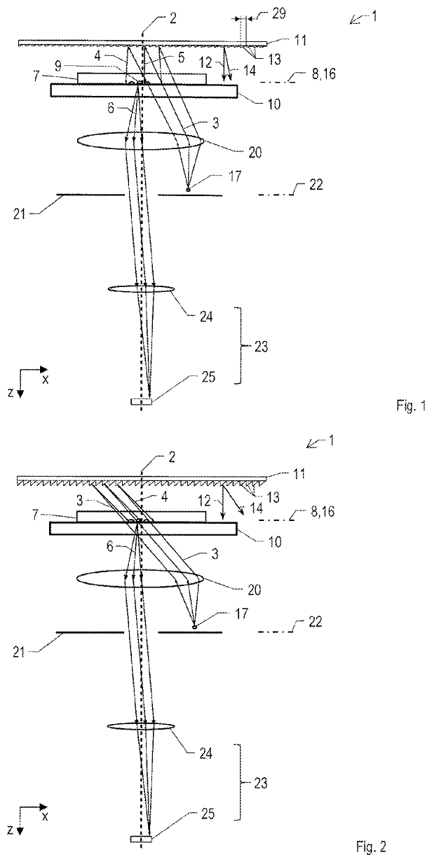

FIG. 2 shows a second exemplary embodiment. Here, in contrast to the first exemplary embodiment, the reflector is embodied as something approximating a retroreflector in relation to the beam 3. It is characteristic that the incident light rays are almost reflected back into themselves. The other reference signs correspond to those of the first exemplary embodiment. The illumination shown in FIG. 2 is a combined reflected light and transmitted light dark field illumination.

FIG. 3 shows a third exemplary embodiment. In contrast to the above exemplary embodiments, the illumination beam 3 is guided past the objective 20 on the outside in this case. The light source 17 here comprises a dedicated collimation apparatus (not shown) for generating a parallel beam. On the basis of this exemplary embodiment, the intersection 26 of the beam 3, i.e., of the beam before the deflection, with the focal plane 16, which also lies in the sample plane 8 in this case, is also shown. The field of view 27 is also shown. The intersection 26 lies outside the field of view 27 in this case. This is a transmitted light dark field illumination. The reflector is embodied in such a way that a rising flank 30 and a falling flank 31 with respect to the z-direction are present in each period. Only the longer rising flanks are used as reflection surfaces 13. The other reference signs correspond to those of the previous exemplary embodiments.

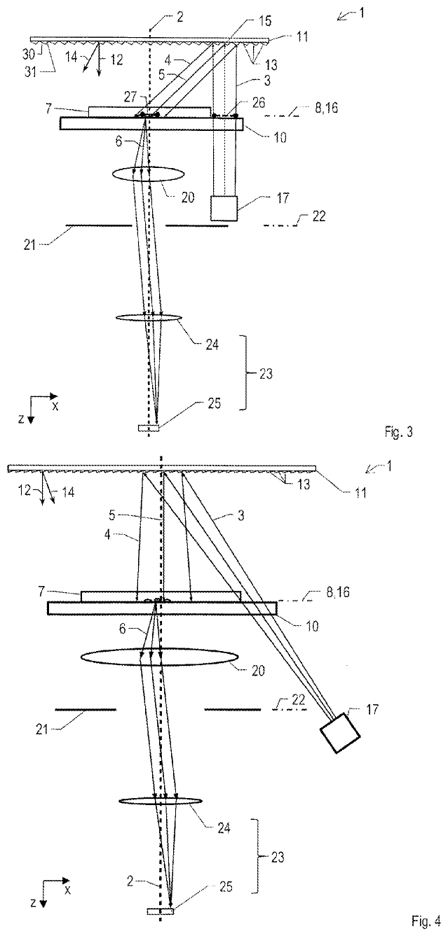

FIG. 4 shows a fourth exemplary embodiment. This is a transmitted light bright field illumination, the illumination beam 3 being guided past the objective 20 on the outside. The other reference signs correspond to those of the previous exemplary embodiments.

FIG. 5 shows a fifth and a sixth exemplary embodiment. In the fifth exemplary embodiment, a first light source 17.a is provided for generating the first beam 3.a. The reflector 11 has V-grooves, a flank 30 rising with respect to the z-direction and a falling flank 31 of the same length being present in each period 29. Both flanks are used as reflection surfaces 13. The shown rays of the beam 3.a are deflected by a first reflection 15.a at a reflection surface and a subsequent second reflection 15.b at another reflection surface. As a result, the substitute perpendicular 14 is dependent on the direction of the incident ray. The first substitute perpendicular 14.a here designates the substitute perpendicular of the central ray of the incident beam 3.a. The interaction of the two individual reflections creates the first deflected beam 4.a, with which the sample is illuminated under an oblique incidence of light. The roof angle 32 is selected here to be less than 90°. The other reference signs correspond to those of the previous exemplary embodiments. In a development of the sixth exemplary embodiment, three reflections (not shown) are provided for deflecting the beam. For this purpose, the reflector can be embodied as a microprism array, for example as a full cube or pyramidal triple microprism array.

In the sixth exemplary embodiment, a second light source 17.b is additionally provided, which can be operated independently of the first light source 17.a. A first image is recorded with the first light source switched on. Then the first light source is switched off and the second light source is switched on. Since the substitute perpendicular depends on the direction of incidence of the light, the reflector 11 now has a second substitute perpendicular 14.b and a second incident beam 3.b is deflected into a second deflected beam 4.b and illuminates the sample from a different direction than the first deflected beam 4.a. A second image of the sample is then recorded under this illumination. A difference image can be calculated from these two images, in which the contrasts of the observed objects can be improved.

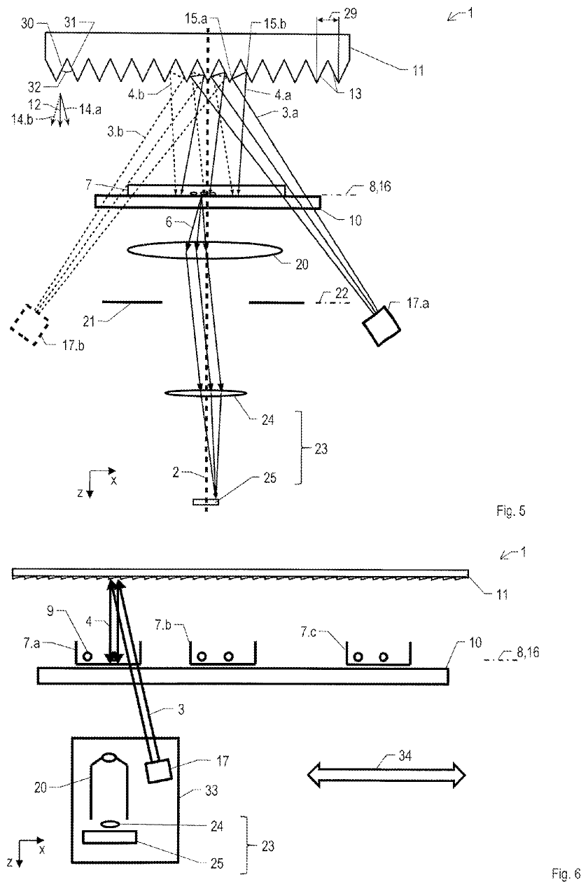

FIG. 6 shows a seventh exemplary embodiment. A plurality of microscopic images of a plurality of samples 7a-c are recorded here. For this purpose, use is made of a scanner unit 33, which carries a microscope camera 23, the objective 20 and the light source 17. This scanner unit is arranged so as to be displaceable 34 in an xy-plane below the samples. The microscope camera comprises the image sensor 25 and a camera lens 24. The light source 17 is fixedly arranged with respect to the microscope camera.

A displacement 34 of the scanner unit 33 with respect to the samples 7 is provided in each case from the recording of one image to the recording of the next image. The reflector 11 is fixedly arranged with respect to the samples.

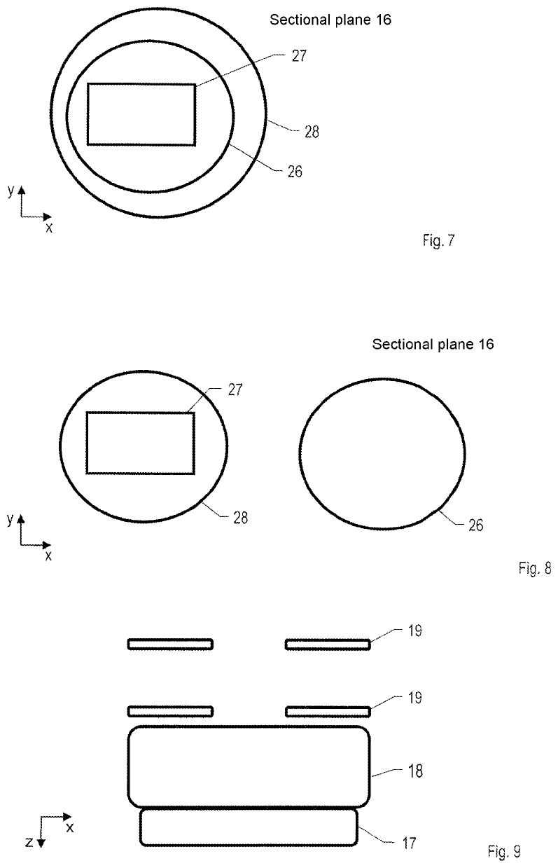

FIG. 7 shows a first embodiment of the illumination beam path in a sectional plane. The sectional plane is the focal plane 16 in this case. The intersection 26 of the incident beam with the focal plane, the field of view 27 and the sample area 28 illuminated by the deflected beam are shown here. It is evident that this is a combined incident light and transmitted light illumination. Such an illumination is shown in the second exemplary embodiment in FIG. 2.

FIG. 8 shows a second embodiment of the illumination beam path in a sectional plane. The sectional plane is the focal plane 16 in this case. The intersection 26 of the incident beam with the focal plane located outside of the field of view, the field of view 27 and the sample area 28 illuminated by the deflected beam are shown here. It is evident that this is a transmitted light illumination.

FIG. 9 shows a light source. The light source is an LED 17. A diffuser 18 and light source stops 19 are situated in front of the light-emitting surface. A homogeneous directional distribution of the illumination light over a limited area can thus be achieved.

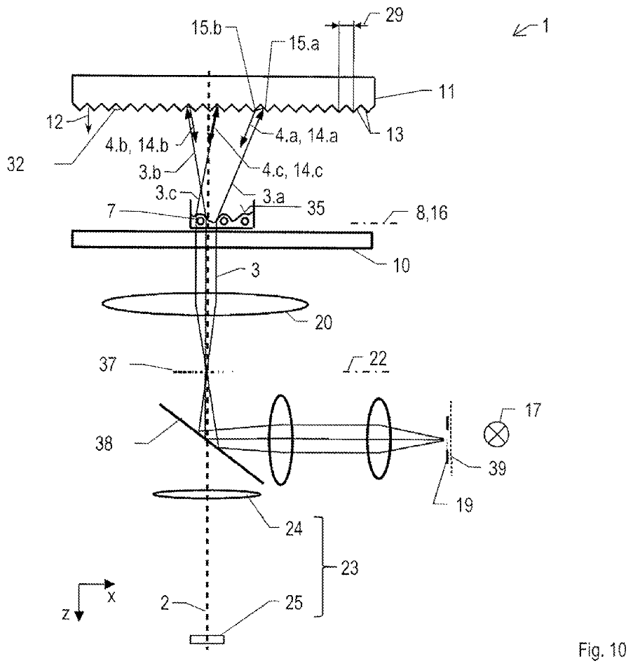

FIG. 10 shows an eighth exemplary embodiment. Here, the reflector 11 is embodied as a retroreflector. When the sample 7 is transilluminated, the beam 3 of the illumination is split into a plurality of beams. This can arise from differences in the refractive index in the sample and/or the refraction at a curved sample back side 35. A first 3.a, a second 3.b and a third beam 3.c are illustrated. These are incident on the retroreflector 11 from different directions. Each beam is reflected back against the direction of incidence at the retroreflector; specifically, the first beam 3.a is reflected back into the first deflected beam 4.a, the second beam 3.b is reflected back into the second beam 4.b and the third beam 3.c is reflected back into the third deflected beam 4.c. Substitute perpendiculars can be assigned to the individual beams here, the direction of which corresponds to the respective emergent ray. The first substitute perpendicular 14.a corresponds to the first deflected beam 4.a, the second substitute perpendicular 14.b corresponds to the second deflected beam 4.b and the third substitute perpendicular 14.c corresponds to the third deflected beam 4.c. The description of the beam path by means of the substitute perpendiculars is redundant in the case of a retroreflector, since the direction of the deflected ray counter to the incident ray is already clearly described by the function of the retroreflector. The beams are deflected by a plurality of reflections; a first reflection 15.a and a second reflection 15.b are given by way of example. In the advantageous embodiment of the reflector as a microprism array, three reflections are provided for deflecting each ray. This can result in a beam offset between the incident and emergent rays. The maximum beam offset is smaller, the smaller the selected period 29, i.e., the structure size of the retroreflector. The extent of the prisms in the case of a prism array or the diameters of glass spheres in the case of embedded glass spheres can be considered as the structure size here. In order to advantageously minimize the beam offset, the use of microprism arrays or the smallest possible embedded glass spheres for the retroreflector can be advantageous. This is because the deflected beams 4.a, 4.b, 4.c are to impinge on the sample back side as close as possible to the beams 3.a, 3.b and 3.c, respectively. Then they can be diffracted in the opposite way to the latter. In this way, transmitted light illumination can be achieved which is parallel or divergent in the same way as the incident beam of the illumination 3. The illustration shows an axially parallel bright field illumination, i.e., the beam of the illumination 3 runs parallel to the optical axis 2. In a development of the exemplary embodiment, not shown, oblique bright field illumination can be provided. In the case of the latter, the beam of the illumination 3 runs at an angle to the optical axis 2. In this exemplary embodiment, the illumination beam is reflected in with a partially transmissive mirror 38.

The illustration also shows an optional configuration for recording a Hoffman modulation contrast image. This optional configuration comprises a modulator 37. The latter comprises three segments of different optical attenuation, which are indicated by dashed lines of different widths. This modulator is normally provided for the observation beam path (not shown). The illumination light is also passed through the modulator in this case. The optional configuration also includes a slit stop (slotted stop) 19. Said stop can be fixed or rotatable and/or displaceable. This stop is partially covered by a polarizer, which is shown in dashed lines. In addition, a further polarizer 39 can optionally be provided, which acts on the entire illumination beam used. The latter can be rotatable.

FIG. 11 shows a ninth exemplary embodiment. In contrast to the aforementioned exemplary embodiment, oblique dark field illumination is provided in this case. A retroreflector 11 is also used in this example. In a development of this exemplary embodiment, provision is made of a second light source (not shown), which can be operated independently of the first light source 17. A respective partial image can then be recorded with one light source switched-on in each case and the microscopic image can be created as a difference image of the two partial images.

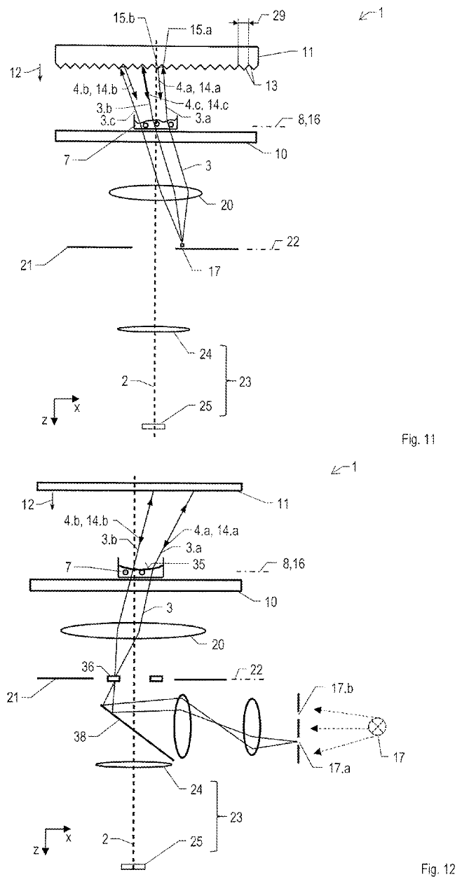

FIG. 12 shows a tenth exemplary embodiment. A phase plate 36, which is embodied as a phase ring, is provided in this case. A first illumination beam path 3, which emanates from a first point light source 17.a, is shown. In addition, further point light sources can be specified, for example a second point light source 17.b in the sectional image shown. In this exemplary embodiment, a ring-shaped illumination is provided, which can be viewed as a plurality of light sources arranged in a ring. The individual light sources 17.a, 17.b can be fed by a single light source 17. As a result, the ring-shaped illumination can be coherent in order to achieve a phase contrast recording as a microscopic image. In this exemplary embodiment, the illumination beam is reflected in with a partially transmissive mirror 38.

In an alternative development of this exemplary embodiment, the phase plate is omitted and one or more bright field recordings of the sample are recorded with oblique illumination.

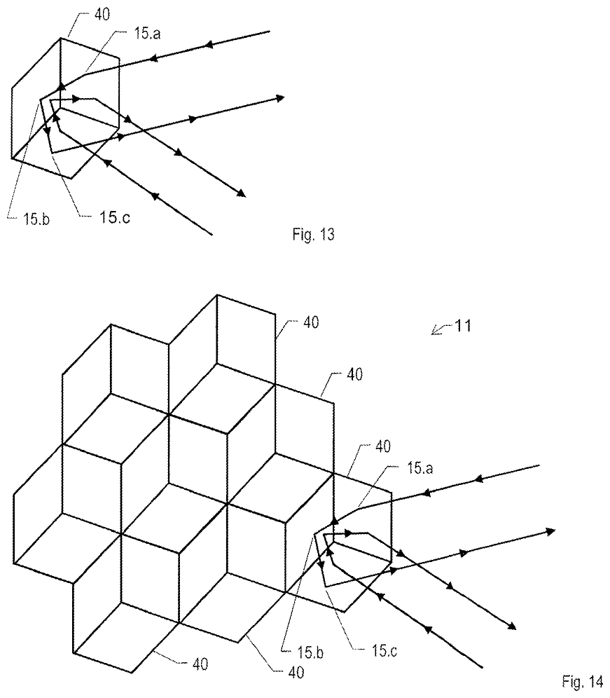

FIG. 13 shows a beam deflection at an element of a microprism array. Each beam is deflected by a first 15.a, a second 15.b and a third reflection 15.c at one of the surfaces of the microprism 40 in each case.

FIG. 14 shows a section from a reflector. The reflector is a retroreflector, which is embodied as a full cube microprism array in this exemplary embodiment. The microprism array includes many tri-faceted microprisms 40. Such retroreflectors can be used in the above exemplary embodiments.

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

What is claimed is:

1. The use of at least one plate-shaped reflector for deflecting at least one illumination beam for illuminating at least one sample for recording at least one microscopic image of the sample from a first side using an image sensor, wherein the plate-shaped reflector has a plate normal and a substitute perpendicular, deviating from the plate normal, in respect of the illumination beam and the reflector is arranged on a second side which is opposite the first side with respect to the sample.

2. A method for recording a microscopic image of at least one region of at least one sample arranged in a sample plane from a first side, comprising
generating at least one beam with the aid of at least one light source,
guiding the beam through the sample plane to a plate-shaped reflector, the reflector being a retroreflector,
deflecting the beam by the reflector,
illuminating the sample with the deflected beam,
recording the microscopic image using an image sensor.

3. The method or use as claimed in claim 1, wherein the sample is arranged in a horizontal sample plane and/or in that the microscopic image is recorded from below in relation to the force of gravity.

4. The method or use as claimed in claim 1, wherein the reflector is embodied in one piece as a plate or a film and/or in that the reflector is embodied as a layer on a carrier plate or a carrier film.

5. The method or use as claimed in claim 1, wherein there is a focal plane which is imaged on the image sensor in focus and in the focal plane there is a field of view which is captured by the image sensor and the illumination beam has an intersection with the focal plane before the deflection and the intersection contains the field of view.

6. The method or use as claimed in claim 1, wherein the beam is guided through the sample plane at a point lying outside a field of view.

7. The method or use as claimed in claim 1, wherein the deflected beam effects a transmitted light bright field illumination or a transmitted light dark field illumination.

8. The method or use as claimed in claim 1, wherein the deflected beam has a central ray which is inclined to an optical axis.

9. The method or use as claimed in claim 1, wherein the light source is an LED.

10. The method or use as claimed in claim 1, wherein a plurality of microscopic images of a plurality of samples and/or of one sample at a plurality of locations are recorded and in that a microscope camera, which comprises the image sensor and a camera lens, is moved, from the recording of one image to the recording of a next image, with respect to the samples or the sample in each case and the reflector is fixedly arranged with respect to the samples or the sample and the light source is fixedly arranged with respect to the microscope camera.

11. The method or use as claimed in claim 1, wherein the reflector is embodied as a periodic relief structure and at least two reflection surfaces are present in each period.

12. The method or use as claimed in claim 1, wherein the reflector is embodied as a microprism array and/or a microlens array.

13. The method or use as claimed in claim 1, wherein the reflector is embodied as a retroreflector embodied as a full cube microprism array or as a pyramidal triple microprism array or comprising encapsulated micro glass beads.

14. The method or use as claimed in claim 1, wherein the beam of the illumination incident on the sample is split in the sample and/or by refraction at a sample back side into at least one first beam and at least one second beam the second beam impinging on the reflector at a different angle of incidence to the first beam

15. The method or use as claimed in claim 1, wherein the beam of the illumination is guided through the microscope objective onto the sample.

16. The method or use as claimed in claim 1, wherein the reflector deflects an incident light ray of the beam by means of at least two successive individual reflections.

17. The method or use as claimed in claim 1, wherein the microscopic image is a phase contrast recording or a superposition of a transmitted light bright field image or a transmitted light dark field image with a phase contrast image.

18. The use as claimed in claim 1, wherein the reflector is embodied as a Fresnel prism, the Fresnel prism comprising several reflection surfaces with reflection surface normals and the reflection surface normals being inclined with respect to the plate normal.

19. A microscope for recording at least one transmitted light bright field image or transmitted light dark field image of at least one sample in at least one field of view, comprising
a beam path comprising at least one illumination beam path and at least one imaging beam path,
at least one light source for generating at least one beam,
a plate-shaped reflector for deflecting the beam, the deflected beam being provided for illuminating the sample and the plate-shaped reflector having a plate normal and a substitute perpendicular, deviating from the plate normal, in respect of the illumination beam,
at least one microscope objective for the imaging beam path,
at least one image sensor.

20. A microscope for recording at least one image of at least one sample in at least one field of view, comprising
a beam path comprising at least one illumination beam path and at least one imaging beam path,
at least one light source for generating at least one illumination beam,
a plate-shaped reflector for deflecting the illumination beam, the deflected illumination beam being provided for illuminating the sample, and the reflector being embodied as a retroreflector,
at least one microscope objective for the imaging beam path,
at least one image sensor,
wherein the illumination beam is guided through the microscope objective before being deflected at the reflector.

21. The microscope as claimed in claim 19, wherein at least one second light source is present in addition to the first light source and a second illumination beam is able to be generated using the second light source and the second light source is operable independently of the first light source, and the plate-shaped reflector is moreover provided for deflecting the second beam the deflected second beam being provided for illuminating the sample.

22. The microscope as claimed in claim 19, wherein there is a focal plane which can be imaged on the image sensor in focus, and the illumination beam has an intersection with the focal plane in the beam path before the deflection at the reflector and the intersection contains the field of view.
